(19) United States
(12) Patent Application Publication
(10) Pub. No.: US 2004/0179351 A1
(43) Pub. Date: Sep. 16, 2004

(54) Liquid dispensing system having a light source attached to a liquid dispensing device

(76) Inventor: Wade C. Patterson, Huntsville, AL (US)

Correspondence Address: REINHART BOERNER VAN DEUREN S.C., ATTN: LINDA GABRIEL, DOCKET COORDINATOR, 1000 NORTH WATER STREET, SUITE 2100, MILWAUKEE, WI, 53202, US

(21) Appl. No.: 10/727,369

(22) Filed: Dec. 4, 2003

Related U.S. Application Data
(60) Provisional application No. 60/430,980, filed on Dec. 4, 2002.

(51) Int. Cl. F21V 33/00

(52) U.S. Cl. 362/96; 362/101; 362/276

(57) ABSTRACT

A liquid dispensing system comprises a liquid dispensing device and a light source that is attached to or located within a close proximity of the liquid dispensing device. Light emitted from the light source illuminates an area in close proximity to the liquid dispensing device. Such light can aid a user by increasing the visibility of various components of the liquid dispensing system. Further, such light can improve the aesthetic appearance of the liquid dispensing system, particularly when the liquid dispensing system is located in an otherwise dimly lit area.

### CROSS-REFERENCE TO RELATED APPLICATIONS

This application claims priority to U.S. Provisional Patent Application No. 60/430,980, filed on Dec. 4, 2002, and entitled “System and Method for Illuminating an Area within Close Proximity of a Liquid Dispensing Device,” which is incorporated herein by reference.

### RELATED ART

Conventional liquid dispensing devices, such as faucets, shower heads, and the like, receive a liquid, such as water, from a liquid source, such as a tank or pipe, and dispense the liquid for use by a user. To control the dispensing of the liquid from the liquid dispensing device, some type of fluid control valve, such as a solenoid, for example, is normally employed to selectively allow or impede the flow of the liquid through the dispensing device. In this regard, when the valve is placed in an open state, liquid is typically allowed to flow through the valve and out of the liquid dispensing device. Further, when the valve is placed in a closed state, liquid is prevented from flowing through the valve, thereby preventing the liquid from being dispensed by the liquid dispensing device.

The valve may be controlled via electrical and/or mechanical components, and the control of valve may be based on manual or automatic inputs. For example, a user may manually control a handle or a knob that mechanically opens and closes the valve. In another example, a sensor, such as an infrared sensor may detect the presence of an object (e.g., a person) within a close proximity of the liquid dispensing device and open the valve in response to such a detection. Various configurations of liquid dispensing devices and various techniques for controlling liquid dispensing devices are well-known in the art.

Unfortunately, liquid dispensing devices are not always located in well-illuminated areas. Moreover, relatively low visibility can hinder a user's operation of a liquid dispensing device that is located in a dimly lit area.

### SUMMARY

Embodiments of the present invention generally pertain to liquid dispensing systems having a light source that illuminates an area in close proximity to a liquid dispensing device.

A liquid dispensing system in accordance with one exemplary embodiment of the present invention comprises a liquid dispensing device and a light source that is attached to the liquid dispensing device. Light emitted from the light source can aid a user by increasing the visibility of various components of the liquid dispensing system. Further, such light can improve the aesthetic appearance of the liquid dispensing system, particularly when the liquid dispensing system is located in an otherwise dimly lit area.

A liquid dispensing system in accordance with another exemplary embodiment of the present invention comprises a liquid dispensing device, a light source, an infrared sensor, and logic. The logic is configured to activate, based on the infrared sensor, the light source such that the light source illuminates the liquid dispensing device.

### BRIEF DESCRIPTION OF THE DRAWINGS

The invention can be better understood with reference to the following drawings. The elements of the drawings are not necessarily to scale relative to each other, emphasis instead being placed upon clearly illustrating the principles of the invention. Furthermore, like reference numerals designate corresponding parts throughout the several views.

FIG. 1 illustrates a side view of a liquid dispensing system in accordance with an exemplary embodiment of the present invention.

FIG. 2 illustrates a faucet of the liquid dispensing system depicted by FIG. 1.

FIG. 3 illustrates an instruction execution system that may be implemented in the liquid dispensing system depicted by FIG. 1.

FIG. 4 illustrates a bottom view of the faucet depicted in FIG. 2.

FIG. 5 illustrates a top view of the faucet depicted by FIG. 2 when the faucet is mounted on a sink counter.

FIG. 6 illustrates a conventional liquid dispensing system for dispensing drinking water.

FIG. 7 illustrates a bubbler of the liquid dispensing system depicted by FIG. 6.

FIG. 8 illustrates a bubbler in accordance with an exemplary embodiment of the present invention.

FIG. 9 illustrates the bubbler of FIG. 8 as it is dispensing water.

FIG. 10 illustrates a front view of the bubbler depicted in FIG. 8.

### DETAILED DESCRIPTION

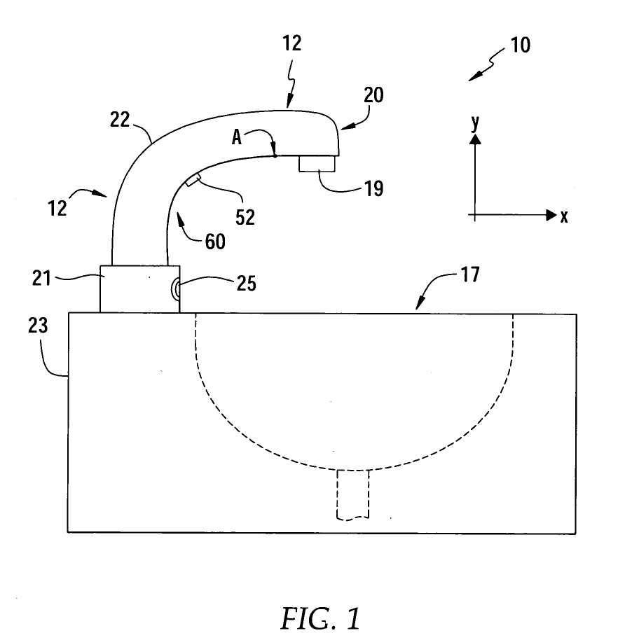

The present invention generally pertains to a system and method for dispensing a liquid and for illuminating an area within close proximity of the dispensed liquid. As an example, FIG. 1 depicts a liquid dispensing system 10 in accordance with an exemplary embodiment of the present invention. As shown by FIG. 1, the system 10 comprises a liquid dispensing device 12, such as a faucet, for example, for receiving a liquid, such as water, from a liquid source, such as a pipe or tank, for example. In the example, shown by FIG. 1, the liquid dispensing device 12 is mounted over a sink 17, and a user may place his hands, or some other object, underneath the device 12 and wash his hands or other object with liquid dispensed from the device 12. Moreover, liquid may be dispensed from an opening 19 in a lower or bottom side of a head 20 of the device 12, and the user may place an object directly below the opening 19 such that water dispensed from the opening 19 flows into and/or over the object.

In the embodiment shown by FIG. 1, the liquid dispensing device 12 comprises a collar 21 and spout 22. The collar 21 may be used to mount the device 12 and/or secure the device 12 on a support structure 23. Integrated with the collar is a sensor 25, such as an infrared sensor, for example, for detecting the presence of an object within close proximity of the device 12. In this regard, the sensor 25 may be configured to detect when an object, such as a user's hands, is placed below the opening 19 or otherwise within a close proximity of the device 12. Note that the sensor 25 may reside in some other location. For example, the sensor 25 may be integrated with the spout 22 instead of the collar 21, or the sensor 25 may be located external to the spout 22 and collar 21. Indeed, the collar 21 is not a necessary feature of the present invention and may be removed from the embodiment shown by FIG. 1, if desired.

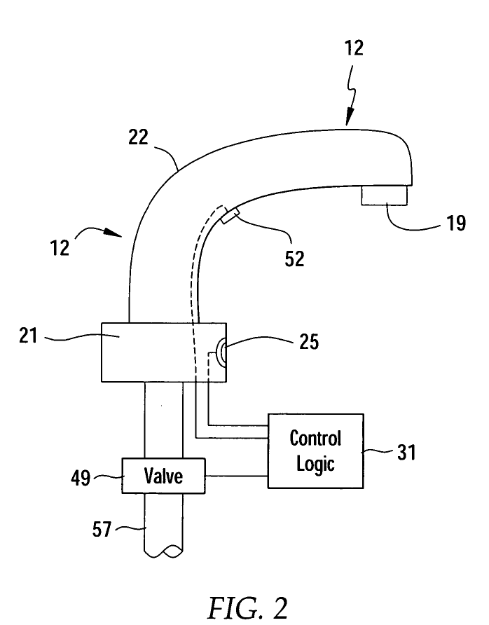

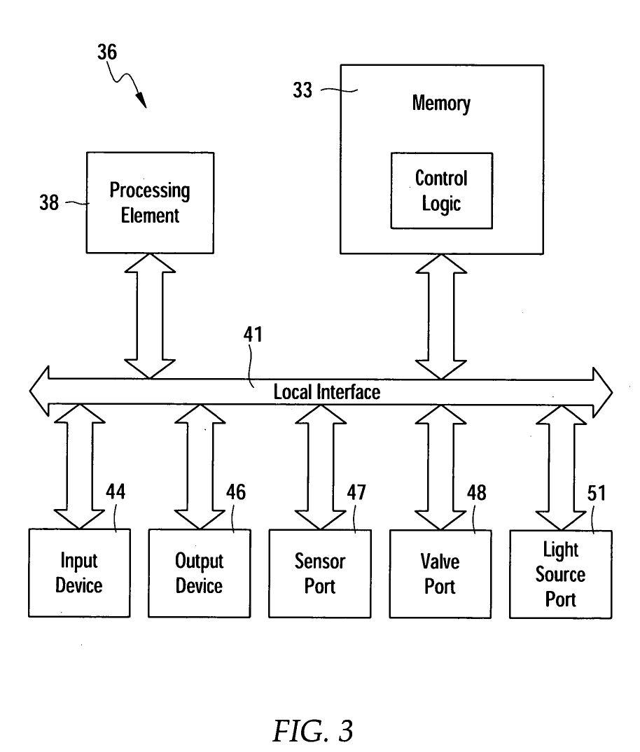

As shown by FIG. 2, the sensor 25 may be electrically coupled to control logic 31, which controls the operation of the liquid dispensing device 12 via techniques that will be described in more detail hereinbelow. Note that the control logic 31 may be implemented via software, hardware, or any combination thereof. In an exemplary embodiment, as illustrated by way of example in FIG. 3, the control logic 31, along with its associated methodology, is implemented in software and stored in memory 33 of an instruction execution system 36.

Note that the control logic 31, when implemented in software, can be stored and transported on any computer-readable medium for use by or in connection with any instruction execution system, apparatus, or device, such as a computer-based system, processor-containing system, or other system that can fetch and execute instructions. In the context of this document, a “computer-readable medium” can be any means that can contain, store, communicate, propagate, or transport a program for use by or in connection with the instruction execution system, apparatus, or device. The computer readable-medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection having one or more wires, a portable computer diskette, a random access memory (RAM), a read-only memory (ROM), an erasable programmable read-only memory (EPROM or Flash memory), an optical fiber, and a portable compact disc read-only memory (CDROM). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory. As an example, the control logic 31 may be magnetically stored and transported on a conventional portable computer diskette.

A preferred embodiment of the system 36 of FIG. 3 comprises at least one conventional processing element 38, such as a digital signal processor (DSP) or a central processing unit (CPU), that communicate to and drive the other elements within the system 36 via a local interface 41, which can include one or more buses. Furthermore, an input device 44, for example, a keypad, can be used to input data from a user of the system 36, and an output device 46, for example, a liquid crystal display (LCD), can be used to output data to the user.

Furthermore, the system 36 may comprise various input/output (I/O) ports for enabling the system 36 to communicate with electronic components external to the system 36. As an example, the system 36 may comprise a sensor port 47 coupled to the sensor 25 for enabling the system 36 to receive data from the sensor 25. The system 36 may also comprise a valve port 48 coupled to a valve 49 (FIG. 2) for enabling the system 36 to control the operation of the valve 49, which will be described in more detail hereinbelow. In addition, the system 36 may comprise a light source port 48 coupled to a light source 52 for enabling the system 36 to selectively activate and deactivate the light source 52, which will be described in more detail hereinbelow.

Note that each of the components of FIG. 3 may be implemented on one or more printed circuit boards (PCBs). In the preferred embodiment, each of the components of the system 36 are implemented on a single PCB, which is positioned within a relatively close proximity of the components 25, 49, and 52 in communication with the system 36. However, the specific arrangement of the components of the system 36 and the specific location of the system 36 are not material aspects of the present invention.

In the embodiment shown by FIG. 2, the control logic 31 controls whether the device 12 dispenses liquid by controlling a state of the valve 49, which may comprise a solenoid or any other switchable device that enables the flow of liquid through the device 12 to be selectively controlled. Moreover, when the control logic 31 determines that the device 12 is to dispense liquid, the logic 31 transmits, via port 48 (FIG. 3), a signal that places the valve 49 in an open state such that liquid flows from a water source, such as a pipe 57, and through the liquid dispensing device 12. Such liquid eventually flows out of the device 12 via the opening 19. When the control logic 31 determines that the device 12 is not to dispense liquid, the logic 31 transmits, via port 48, a signal that places the valve 49 in a closed state such that liquid is prevented from flowing from the pipe 57 and through the liquid dispensing device 12. As a result, liquid is not dispensed from the device 12.

In one exemplary embodiment, the control logic 31 is configured to determine whether or not liquid is to be dispensed by the device 12 based on data from the sensor 25. In this regard, the logic 31 may be configured to determine that liquid is to be dispensed and that the valve 49 is, therefore, to be opened when the sensor 25 detects the presence of an object, such as a user's hands, within close proximity of the liquid dispensing device 12. Thus, when a user places an object underneath the opening 19, the sensor 25 automatically detects the presence of the object and transmits, to the control logic 31, a signal indicative of the detection. In response, the control logic 31 preferably activates the valve 49 or, in other words, places the valve 49 in an open state such that liquid is dispensed from the device 12.

The control logic 31 may be configured to keep the valve 49 in an open state for a predetermined amount of time and to deactivate the valve 49 or, in other words, place the valve 49 in a closed state upon expiration of the predetermined amount of time. Alternatively, the control logic 31 may be configured to deactivate the valve 49 based on data from the sensor 25. In this regard, based on the data from the sensor 25, the logic 31 may determine when the previously detected object has been removed or has left the monitored range of the sensor 25. In response to such a determination, the control logic 31 may be configured to deactivate the valve 49. When deactivated, the valve 49 prevents liquid from flowing through the liquid dispensing device 12 and, therefore, prevents the device 12 from dispensing liquid.

Note that, in other embodiments, other techniques for controlling the dispensing state of the device 12 may be employed without departing from the principles of the present invention. For example, the valve 49 may be activated and/or deactivated based on manual inputs from a user.

As shown by FIGS. 1 and 2, a light source 52, such as one or more light emitting diodes (LEDs) or incandescent light bulbs, for example, is preferably integrated with the liquid dispensing device 12. This light source 52 is preferably utilized to illuminate an object placed within a close proximity of the device 12. For example, if a user places an object, such as his hands, underneath the opening 19 for enabling liquid from the opening 19 to flow over or into the object, the light source 52 may be used to illuminate the object thereby providing increased or better illumination of the object.

Note that there are various methodologies that may be employed for controlling the light source 52. For example, the light source 52 may be automatically controlled such that when a user comes within a close proximity of the device 12 or otherwise places an object, such as his hands, within a close proximity of the device 12, the light source 52 is automatically activated. Alternatively, the light source 52 may be manually controlled such that a user may manually activate and/or deactivate the light source 52. As used herein, the light source 52 is referred to as being “activated” when it is placed in a state that causes the light source 52 to emit light, and the light source is referred to as being “deactivated” when it is placed in a state that prevents the light source 52 from emitting light or that causes the light source 52 to emit light at a substantially lower intensity than when the light source 52 is “activated.” Note that, if desired, the light source 52 may be configured to constantly remain in the activated state.

If the activation state of the light source 52 is to be manually controlled, the system 10 may comprise a switchable input device, (not shown), such as a button, for example, that is electrically coupled to the light source 52. Such an input device may be integrated with the liquid dispensing device 12 or may be positioned at some desirable location external to the device 12. When activated by a user, the switchable input device may allow electrical current to flow to the light source 52 causing the light source 52 to emit light. When deactivated by a user, the switchable input device may prevent the electrical current from flowing to the light source 52 preventing the light source from emitting light. Alternatively, the switchable input device, when deactivated, may reduce the electrical current flowing to the light source 52 causing the light source 52 to emit light having a lower intensity.

If the activation of the light source 52 is to be automatically controlled, the same sensor 25 used to control the dispensing of liquid may also be used to control the activation state of the light source 25. In this regard, when the sensor 25 detects the presence of an object within close proximity of the device 12, as described above, the control logic 31 may be configured to activate the light source 52 in addition to placing the valve 49 into an open state. Therefore, when an object is placed within close proximity of the liquid dispensing device 12, the device 12 automatically begins to dispense liquid, and the light source 52 automatically begins to emit light.

Note that the light source 52 may be deactivated according to the same techniques used to stop the device 12 from dispensing liquid. In this regard, the control logic 31 may be configured to deactivate the light source 52 after a predetermined amount of time since activation has expired. Alternatively, the control logic 31 may deactivate the light source 25 based on data from the sensor 25. For example, the control logic 31 may deactivate the light source 25 based on when the data from the sensor 25 indicates that the detected object is no longer within the close proximity of the device 12. Therefore, the light source 52 may automatically be deactivated when the device 12 stops dispensing liquid or a predetermined amount of time thereafter.

Further note that it is not necessary for activation and/or deactivation of the light source 52 to be consistent with the dispensing of liquid. In this regard, the activation and deactivation of the light source 25 may be controlled, according to the foregoing techniques, such that the light source 52 is activated when the device 12 is dispensing liquid and/or such that the light source 52 is deactivated when the device 12 stops dispensing liquid. However, in other embodiments, the light source 52 may be activated before or after dispensing of the liquid is commenced, and the light source 52 may be deactivated before or after dispensing of the liquid is stopped.

Indeed, if desired, the sensor 25 may be configured to detect objects within different ranges for the purposes of separately controlling the dispensing of liquid and the activation state of the light source 52. For example, the sensor 25 may be configured to detect whether an object is in a first range from the sensor 25, and the logic 31 may be configured to control the state of the valve 49 based on whether an object is detected within this first range. Further, the sensor 25 may also be configured to detect whether an object is in a second range (either shorter or longer than the first range) from the sensor 25, and the logic 31 may be configured to control the state of the light source 25 based on whether an object is detected within this second range. Therefore, as a user approaches the liquid dispensing device 12, the device 12 may automatically begin dispensing liquid and the light source 52 may automatically begin emitting light at different times based on the distance of the user from the liquid dispensing device 12. Further, as a user leaves the device 12, the device 12 may automatically stop dispensing liquid and the light source 52 may automatically stop emitting light at different times based on the distance of the user from the device 12.

In addition, it is not necessary for the same sensor 25 to provide data for controlling both the state of the light source 52 and the state of the valve 49. In this regard, a first sensor may be used to detect the presence of an object for the purpose of controlling the light source 52, and a second sensor may be used to detect the presence of an object for the purpose of controlling the valve 49. However, employing the same sensor 25 to control both the state of the light source 52 and the state of the valve 49 generally helps to reduce the size and cost of the components used to control the operation of the system 10.

Furthermore, when dispensing of a liquid from the device 12 is manually controlled, the same input device (not shown) used to control the dispensing of the liquid may be used to control the activation of the light source 52. For example, a conventional liquid dispensing device often comprises a handle, knob, or some other input device that enables a user to manually control the dispensing of a liquid from the dispensing device.

This same input device may be used to control activation of the light source 52. For example, when a user manipulates the input device such that dispensing of the liquid is commenced, the light source 52 may be activated. Further, when a user manipulates the input device such that dispensing of the liquid is stopped, the light source 52 may be deactivated or may be deactivated some predetermined amount of time thereafter. Thus, the light source 52 is activated when liquid is being dispensed from the device 12. Note that various other techniques for controlling the activation and/or deactivation of the light source 25 are possible.

In some embodiments, the sensor 25 or another component of the system 10 may be configured to detect an amount of ambient light present in a proximity close to the liquid dispensing device. Data indicative of this amount may be transmitted to the control logic 31, which controls an intensity of the light output by the light source 52 based on the detected amount of ambient light. As an example, the control logic 31 may be configured to cause the light source 52 to emit higher intensity light when the detected ambient light is greater and to emit lower intensity light when the amount of detected ambient light is lesser. Conversely, the control logic 31 may be configured to cause the light source 52 to emit higher intensity light when the detected ambient light is lesser and to emit lower intensity light when the amount of detected ambient light is greater. Other methodologies for controlling the intensity of light emitted from the light source 52 are possible for other embodiments.

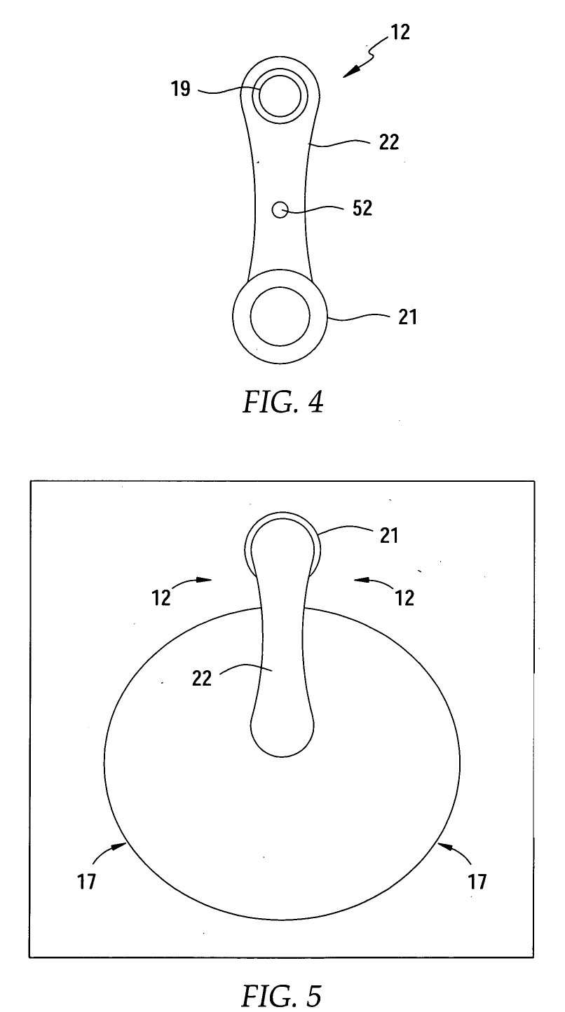

Although the light source 52 may be integrated into the device 12 at any desirable location, the light source 52 is preferably positioned on a bottom side (i.e., a side facing the sink 17) of the spout 22, as shown by FIGS. 1 and 4. Note that, in the embodiment shown by FIGS. 1 and 4, both the light source 52 and the opening 19 from where liquid is dispensed are located on the same bottom side of the spout 22. Further, the light source 52 is preferably positioned on the bottom side of the spout 22 such that the light source 25 is likely to be above an object positioned within the liquid stream dispensed from the opening 19. This can be generally achieved by positioning the light source 52 within the curvature 60 of the spout 22 or at a point further along the x-direction. Note that the height (relative to the y-direction) of the bottom side of spout 22 generally increases as the position in the x-direction increases from the collar 21 until a point (i.e., point “A”) is reached where the bottom side is substantially parallel to the x-direction. Thus, until point “A” is reached, the height of the light source 52 can be generally increased by moving the source 52 forward in the x-direction.

Moreover, by positioning the light source 52 as described above, it is likely that the light source 52, if activated, will directly illuminate the top of an object (i.e., the side of the object facing the bottom side of the spout 22) placed within the stream of liquid dispensed from the opening 19. Noting that the user normally sees the top of the object placed underneath the opening 19, the aforementioned positional arrangement of the light source 52, in general, better illuminates the object. In this regard, a substantial amount of light from the light source 52 reflects off of the top of the object and can be readily seen by the user. If the light source 52 is place at another position, for example, integrated into the collar 21 along with the sensor 25, then a substantial amount of light from the source 52 may illuminate a side of the object not be seen by the user thereby reducing the effect of having the light source illuminate the object.

In addition, it should be emphasized that it is not necessary to have the light source 52 integrated with the liquid dispensing device 12. For example, the light source 52 may be mounted on the rim of the sink 17 or at some other desirable location. Indeed, mounting the light source 52 on the rim of the sink at a position opposite of the device 12 (e.g., at a position of the rim that is closest to the user) may enable a substantial amount of light from the source 52 to illuminate a side of the object that is visible to the user. Note that the same sensor 25 or input device (not shown) used to control the state of valve 49 may be used to control the activation state of the light source 52 even when the light source 52 is not an integral component of the liquid dispensing device 12.

It should also be noted that a light source 52 may similarly be used to provide additional illumination for other liquid dispensing systems, such as showers, drinking fountains, urinals, water coolers, etc. A light source 52 may be integrated with a liquid dispensing device within such a system such that the light source 52 is an integral component of the device, or the light source 52 may reside at a location external to the liquid dispensing device. Further, as described above, the same sensor or input device used to control dispensing of a liquid from the liquid dispensing device may also be used to control the activation and/or deactivation of the light source 52. However, separate sensors and/or input devices may be used to respectively control the dispensing of liquid and the activation state of the light source 52.

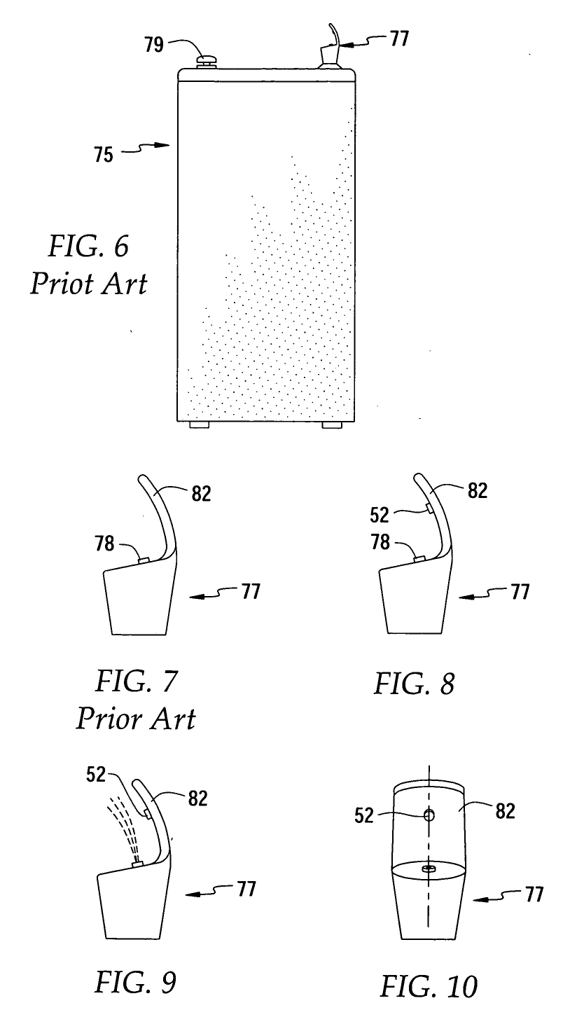

To illustrate another type of liquid dispensing system that may be used to dispense liquid in accordance with present invention, refer to FIGS. 6-10. In this regard, FIG. 6 depicts a conventional system 75 for dispensing drinking water. The system 75, sometimes referred to as a “water fountain,” typically has a liquid dispensing device 77, sometimes referred to as a “bubbler,” that dispenses water from an opening 78 in the device 77 based on control inputs received from an input device 79, such as a button or handle. As shown by FIG. 7, the liquid dispensing device 77 typically employs a shield 82. This shield 82 helps to deter users from placing their mouths on the device 77 where water is dispensed, and the shield 82 also helps to prevent the dispensed liquid from splashing off of the top surface of the system 75. As shown by FIGS. 8-10, a light source 52 may be positioned on a surface of the shield 82 or otherwise integrated with the shield 82 or other portion of the dispensing device 77. Various other locations of the light source 52 are possible in other embodiments.

It should be emphasized that the above-described embodiments of the present invention, particularly, any “preferred” embodiments, are merely possible examples of implementations, merely set forth for a clear understanding of the principles of the invention. Many variations and modifications may be made to the above-described embodiments of the invention without departing substantially from the spirit and principles of the invention.

Now, therefore, the following is claimed:

1. A liquid dispensing system, comprising:
a liquid dispensing device; and
a light source attached to the liquid dispensing device.

2. The system of claim 1, wherein the light source comprises a light emitting diode.

3. The system of claim 1, wherein the liquid dispensing device comprises a faucet mounted over a sink, the faucet attached to the light source.

4. The system of claim 3, wherein the light source is arranged such that the light source illuminates a surface of the sink.

5. The system of claim 1, wherein the liquid dispensing device comprises a bubbler attached to the light source.

6. The system of claim 5, wherein the bubbler has a shield attached to the light source.

7. The system of claim 1, further comprising an infrared sensor and logic, the logic configured to activate the light source based on the infrared sensor.

8. The system of claim 7, wherein the logic is further configured to control whether the liquid dispensing device dispenses liquid based on the infrared sensor.

9. The system of claim 1, further comprising:
a sensor configured to detect when an object is within a specified range from the sensor; and
logic configured to activate the light source based on the sensor.

10. The system of claim 9, wherein the logic is configured to control whether the liquid dispensing device dispenses liquid based on the sensor.

11. A liquid dispensing system, comprising:
a liquid dispensing device;
a light source;
an infrared sensor; and
logic configured to activate, based on the infrared sensor, the light source such that the light source illuminates the liquid dispensing device.

12. The system of claim 11, wherein the logic is further configured to control the liquid dispensing device based on the infrared sensor.

13. The system of claim 11, wherein the light source is attached to the liquid dispensing device.

14. The system of claim 11, wherein the light source comprises a light emitting diode.

15. The system of claim 11, wherein the liquid dispensing device comprises a faucet mounted over a sink, the faucet attached to the light source.

16. The system of claim 11, wherein the liquid dispensing device comprises a bubbler attached to the light source.

17. The system of claim 16, wherein the bubbler has a shield attached to the light source.

18. A method for use with a liquid dispensing system, comprising the steps of:
dispensing liquid from a liquid dispensing device of the liquid dispensing system; and
illuminating an area in close proximity to the liquid dispensing device via a light source attached to the liquid dispensing device.

19. The method of claim 18, wherein the light source comprises a light emitting diode.

20. The method of claim 18, wherein the liquid dispensing device comprises a faucet mounted over a sink, the faucet attached to the light source.

21. The method of claim 20, further comprising the step of illuminating a surface of the sink with light emitted by the light source.

22. The method of claim 18, wherein the liquid dispensing device comprises a bubbler that is attached to the light source.

23. The method of claim 22, wherein the bubbler has a shield attached to the light source.

24. A method for use with a liquid dispensing system, comprising the steps of:
controlling a liquid dispensing device;
detecting when an object is within a specified range of the liquid dispensing device;
activating a light source based on the detecting step; and
illuminating the liquid dispensing device with the light source.

25. The method of claim 24, wherein said detecting step is based on an infrared sensor.

26. The method of claim 24, wherein the controlling step is based on the detecting step.

27. The method of claim 24, wherein the light source is attached to the liquid dispensing device.

28. The method of claim 24, wherein the light source comprises a light emitting diode.
